(19) United States
(12) Patent Application Publication
(10) Pub. No.: US 2007/0207678 A1
(43) Pub. Date: Sep. 6, 2007

(54) Contact Sleeve for Stranded Conductor Connections

(75) Inventor: Manfred Aulmann, Schalksmuhle (DE)

Correspondence Address: WILLIAM COLLARD;COLLARD & ROE, P.C., 1077 NORTHERN BOULEVARD, ROSLYN, NY, 11576, US

(73) Assignee: SCHULTE ELEKTROTECHNIK GMBH & CO. KG, Ludenscheid (DE)

(21) Appl. No.: 11/632,798

(22) PCT Filed: Sep. 8, 2005
(86) PCT No.: PCT/EP05/09638

§ 371 Date: Jan. 18, 2007

(30) Foreign Application Priority Data
Sep. 10, 2004 (DE) 10 2004 043 774.2

(51) Int. Cl. H01R 24/04

(52) U.S. Cl. 439/669

(57) ABSTRACT

The invention relates to a contact sleeve for cable connections. The contact sleeve is formed by a bent part which comprises a clamping area (1) for cables and a plug-in area (2). The clamping area (1) and the plug-in area (2) are connected together by means of a frame (3). The plug-in area (2) comprises a receiving element (28) for an insertion tongue. Two chambers (29) are embodied in the plug-in area (2) which are arranged adjacent to the receiving element (28).

The invention relates to a contact sleeve for stranded conductor connections, formed by a bent part that has a clamping region for stranded conductors and a plug-in region having an accommodation for a plug-in tongue, whereby the clamping region and plug-in region are connected with one another by way of a crosspiece.

Stranded conductors are electrically conductive, wound or braided wires that are provided with an insulation mantling made of plastic. To make a connection with devices, switches, or the like, the ends of the stranded conductors are freed from the mantling, and pressed together with a contact sleeve. Before pressing, the ends of the stranded conductors are freed from the mantling. This exposed part is referred to as the “lead end” in the following.

Contact sleeves for stranded conductor connections are known, as such. They have a clamping region at their one end, into which the stranded conductors to be clamped are introduced. The clamping region has tabs that stand essentially vertically upward in the non-assembled state. After the stranded conductors are laid in, the two tabs are clamped around the stranded conductor with a clamping tool. The lead end, which produces the contact between the wire and the sleeve, is disposed in the region of the crosspiece in the assembled state, which crosspiece also has two tabs, which are, however, shorter in its dimensions, which surround the lead end after the clamping procedure. At the end facing away from the clamping region, a plug-in region is configured on the known contact sleeves, which serves to accommodate a plug-in tongue.

The known contact sleeves fulfill the tasks set for them. However, because of their geometry, they are unsuitable for certain installation positions, since the clamping region for the stranded conductor extends relatively far over the longitudinal center line of the contact sleeve. This is disadvantageous, in particular, in the case of very tight installation conditions. Furthermore, there is the disadvantage that different contact sleeves are required for different thicknesses of plug-in tongues, which sleeves must be produced with different tools. In this connection, the adaptation of the plug-in region of the contact sleeve to the different thicknesses of the plug-in tongues takes place in an independent work step, before the stranded conductors are connected with the contact sleeves. Therefore, different contact sleeves for use with plug-in tongues having different thickness must also be kept on hand.

This is where the invention wants to provide a remedy. The invention is based on the task of creating a contact sleeve for stranded conductor connections that contains a compact construction and allows making the connection with plug-in tongues having different thickness, with only a single bent part. According to the invention, this task is accomplished in that two chambers are formed in the plug-in region, which are disposed adjacent to the accommodation element.

With the invention, a contact sleeve for stranded conductor connections is created, which has an extraordinarily compact construction. This compact construction is brought about by not configuring the crosspiece as a contact point for the stranded conductor, since this is not required as compared with the known contact sleeves. Instead, the contact point of the stranded conductor is provided in the chambers that are disposed over the plug-in region. Furthermore, the connection with plug-in tongues having different thickness is made from only one bent part. The adaptation to the thickness of the plug-in tongue only takes place at the moment when the stranded conductor is also connected with the contact sleeve.

In a further development of the invention, the chambers are separate from one another. In this way, the possibility is created of connecting two stranded conductors in one contact sleeve, thereby increasing the usage possibilities of the sleeve.

In an embodiment of the invention, the plug-in region is provided with a bore. The bore serves as a holding point for an embossing on the plug-in tongues. When the plug-in tongue is introduced into the accommodation, the embossing catches in the bore, so that a reliable connection is brought about.

In another further development of the invention, the clamping region is formed by two shanks, at the free ends of which drawn-in parts that face inward are formed. In this way, an approximately closed circumference of the clamping region is formed after crimping, thereby reliably clamping the stranded conductor(s).

Other embodiments and further developments of the invention are indicated in the other dependent claims. An exemplary embodiment of the invention is shown in the drawing and will be described in detail below. The drawing shows:

FIG. 1 the view from the bottom of a contact sleeve for stranded conductor connections;

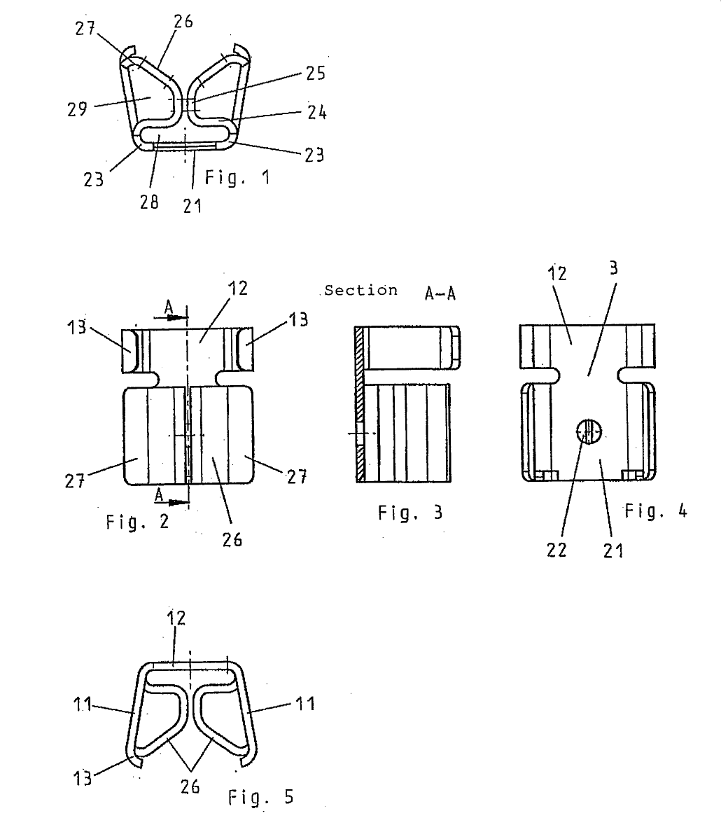

FIG. 2 the front view of the contact sleeve shown in FIG. 1;

FIG. 3 the section along the line A-A in FIG. 2;

FIG. 4 the side view from the right of the contact sleeve shown in FIG. 1;

FIG. 5 the top view of the contact sleeve shown in FIG. 1;

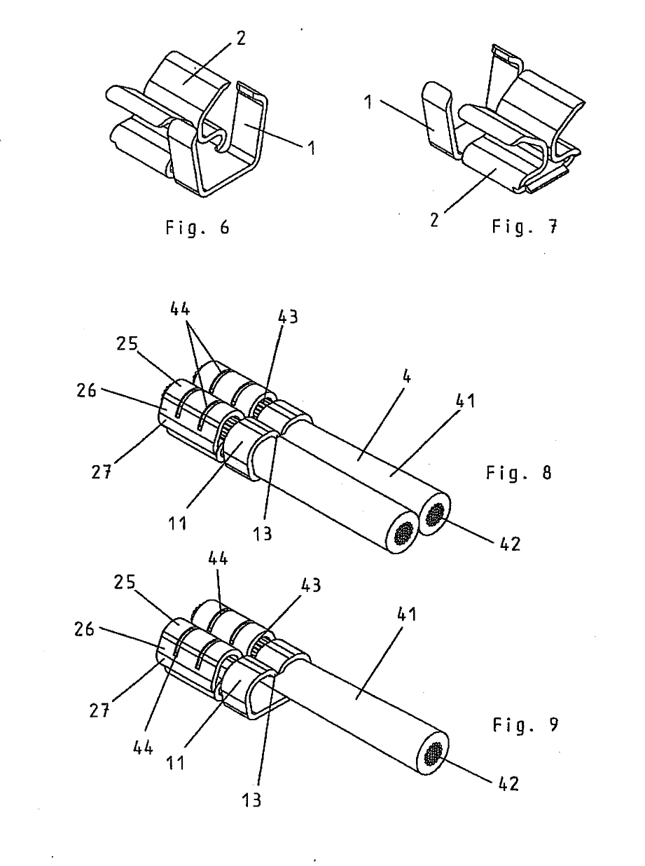

FIG. 6 a perspective representation of the contact sleeve shown in FIG. 1;

FIG. 7 a three-dimensional representation of the contact sleeve shown in FIG. 1, from a different perspective;

FIG. 8 a three-dimensional representation of a contact sleeve with two stranded conductors connected, and

FIG. 9 a three-dimensional representation of a contact sleeve with one stranded conductor connected.

The contact sleeve for stranded conductor connections selected as an exemplary embodiment is formed by a punched/bent part that is produced from a conductive metal alloy. The clamping sleeve has a clamping region 1 for stranded conductors 4 and a plug-in region 2 for a plug-in tongue, not shown. Clamping region 1 and plug-in region 2 are connected with one another by way of a crosspiece 3.

The clamping region 1 is formed by two shanks 11 that stand in connection with one another by way of a base 12. In the exemplary embodiment, the shanks 11 are oriented not at a right angle to the base 12, but rather have an angle relative to the vertical, in each instance. Drawn-in parts 13 that turn inward are formed at the free ends of the shanks 11.

The crosspiece 3 proceeds from the base 12. The crosspiece 3 ends in a bottom 21 of the plug-in region 2. A bore 22 is provided in the bottom 21. In the assembled state, the bore 22 serves to accommodate an embossing on a plug-in tongue, not shown. The plug-in tongue catches in the contact sleeve with the embossing.

At its two longitudinal sides, the bottom 21 is followed by half-cylinders 23, which make a transition into segments 24, in each instance. The segments 24 are followed by walls 25 oriented at a right angle to the bottom 21, which make a transition into shanks 26. The shanks 26 are disposed at an angle relative to one another. In the bottom view according to FIG. 1, an essentially Y-shaped configuration is obtained when looking at the walls 25 and the shanks 26 together. At their free ends, bent-in edges 27 directed outward are provided on the shanks 26.

By means of the configuration of the plug-in region 2 as described above, an accommodation 28 for a plug-in tongue is brought about, on the one hand, when looking at bottom 21, half-cylinder 23, and segments 24 together. On the other hand, two chambers 29 that are open towards the outside are formed by means of looking at the segments 24, walls 25, as well as shanks 26 and edges 27 together. A closure of the chambers 29 that takes place in the assembly direction is brought about using the shanks 11 of the clamping region 1, as can be seen in FIGS. 1 and 5.

The stranded conductors 4 have a mantling 41 in which a wire 42 is provided. At their end, the stranded conductors 4 are freed from the mantling 41, so that the wire is exposed. This exposed part is referred to as the lead end 43.

When using the contact sleeve according to the invention, first the sleeve is produced as a punched/bent part. Then the connection with one or two stranded conductors can be made. For this purpose, the stranded conductor, in each instance, is introduced into the sleeve from the direction of the clamping region 1, until the lead end of the stranded conductor has reached the chamber 29. If a connection is being made with only one stranded conductor, only one stranded conductor is introduced into the sleeve in the manner described above. When using two stranded conductors, introduction of the stranded conductors can take place at the same time or one after the other. The use of two stranded conductors is possible without problems, since there is sufficient room for two mantled stranded conductors because of the configuration of the clamping region 1, on the one hand; on the other hand, two chambers 29 that are separated from one another are formed by means of the configuration of the plug-in region 2, thereby precluding mutual interference of the stranded conductors.

The contact with a plug-in tongue takes place by means of simple introduction of the tongue into the accommodation 28. If an embossing is disposed on the plug-in tongue, this catches in the bore 22.

The final connection of the stranded conductor(s) with the contact sleeve takes place by means of a tool. In this connection, both the shanks 11 of the clamping region 1 and the shanks 26 of the plug-in region 2 are bent around. The shanks 11 of the clamping region 1 bend inward during the clamping procedure, so that the mantled part of the one or both stranded conductors is clamped in. In this connection, the drawn-in parts 13 that are directed inward bring about an improvement in the hold of the stranded conductors, since the orientation of the drawn-in parts 13 leads to a completely surrounded circumference of the clamping region 1 in the most extreme case, so that the one or two stranded conductors are clamped so that they cannot come loose. The shanks 26, in contrast, are bent outward, whereby the bent-in edges 27 also bring about an improvement in the hold of the lead ends here, since the bent-in edges 27 can engage over the one or the two lead ends 43 (FIGS. 8 and 9). In FIGS. 8 and 9, it can be seen that the mantled region of the stranded conductors is clamped in by means of the shanks 11 with the drawn-in parts 13, whereas the shanks 26 with the edges 27 surround the lead end 43 of the stranded conductors, clamping it. Consequently, they form the contact point between the wire 42 and the contact sleeve. In this embodiment, the walls 25 in the plug-in region 2 are provided with cross-ribs 44 disposed parallel to and at a distance from one another. The cross-ribs 44 allow better, permanent pressing of the wires 42 together with the contact sleeve.

The contact sleeve according to the invention has a significantly more compact construction than the contact sleeves known from the state of the art. It therefore offers itself for use even under very tight installation conditions. Furthermore, there is the possibility of connecting one (FIG. 9) or two (FIG. 8) stranded conductors with the contact sleeve, whereby two chambers, separate from one another, are formed, which prevent the stranded conductors from mutually hindering one another. The compact construction is brought about, among other things, due to the fact that the contact point of the stranded conductors occurs in the chambers, which are disposed directly adjacent to the accommodation for the plug-in tongue.

Furthermore, the following should be noted: In the case of contact sleeves, heat occurs due to the flow of current in the plug-in region of the tongue. This heat must be conducted away, and this takes place by way of the wire 42. In the case of the contact sleeves known from the state of the art, the path for carrying the heat away from the plug-in connection with the tongue to the copper wire is long. Furthermore, there is a narrowing in cross-section on this path, in the form of the crosspiece. In the case of the contact sleeve according to the present invention, on the other hand, the copper wire of the stranded conductor, which carries away the heat, is directly above the plug-in tongue accommodation, so that the heat can be carried away by the shortest possible path. This results in an improvement in heat removal.

1. Contact sleeve for stranded conductor connections, formed by a bent part that has a clamping region for cables and a plug-in region having an accommodation for a plug-in tongue, whereby the clamping region and plug-in region are connected with one another by way of a crosspiece, wherein two chambers (29) are formed in the plug-in region (2), which are disposed adjacent to the accommodation (28).

2. Contact sleeve according to claim 1, wherein the chambers (29) are separate from one another.

3. Contact sleeve according to claim 1, wherein the plug-in region (2) is provided with a bore (22).

4. Contact sleeve according to claim 1, wherein the clamping region (1) is formed by two shanks (11), at the free ends of which drawn-in parts (13) that are directed inward are configured.

5. Contact sleeve according to claim 1, wherein walls (25) are provided in the plug-in region (2), which are provided with cross-ribs (44).
